(19) United States
(12) Patent Application Publication
(10) Pub. No.: US 2026/0102904 A1
(43) Pub. Date: Apr. 16, 2026

(54) AN INTERFACE FOR A MODULAR SYSTEM OF CONFIGURABLE DEVICES FOR ADJUSTABLE ROBOTIC PRODUCTION LINES

(71) Applicant: FlexLink AB, Göteborg (SE)

(72) Inventor: Bastien Fusy, Siccieu (FR)

(21) Appl. No.: 19/114,712

(22) PCT Filed: Sep. 22, 2023
(86) PCT No.: PCT/EP2023/076264

§ 371 Date: Mar. 24, 2025

(30) Foreign Application Priority Data
Sep. 30, 2022 (FR) FR2210020

(51) Int. Cl. B25J 9/00; B65G 37/02; H01R 13/62

(52) U.S. Cl. CPC B25J 9/0093; B65G 37/02; H01R 13/6205

(57) ABSTRACT

An interface (140) adapted to be arranged on a first conveyor system module (110, 120, 130) and adapted to releasably interconnect with a corresponding interface on a second conveyor system module. The interface comprises first electric connection means (511) configured to supply power between the first and the second conveyor system modules (110, 120, 130), second electric connection means (512) configured to transmit control signals between the first and the second conveyor system modules (110, 120, 130), magnetic attachment means configured to magnetically attach the first conveyor system module (110, 120, 130) to the second conveyor system module (110, 120, 130), and mechanical alignment means configured to align the interface of the first conveyor system module (110, 120, 130) with the corresponding interface of the second conveyor system module (110, 120, 130).

### TECHNICAL FIELD

The present disclosure relates to a modular conveyor system comprising a plurality of conveyor system modules, such as a conveyor module with a conveyor, a robot module comprising a robot arm with a head arranged to interact with objects on the conveyor, and a power module. In particular, the present disclosure relates to interfaces for interconnecting such of conveyor system modules.

### BACKGROUND

Robotic production lines typically comprise a plurality of robots arranged along a conveyor path where objects are conveyed while being processed. Conveying devices provide the conveyor path and usually comprise a conveying track in the form of a belt or a chain. Conveyor belts are often used for straight conveyor systems, where the object is conveyed in a single direction, or when the object is diverted from one straight belt to another straight belt. In conveyor systems where the object is to pass through bends and curves, an endless chain conveyer is of advantage. The conveying tracks can be recessed in a trench with vertical side surfaces. Alternatively, they can be located on the horizontal upper surfaces of the trench or arranged in some other way.

Robots are often used for loading and unloading along the conveyor path. One common use is to move products from a pallet onto the conveyor path at the beginning of the production line. Another common use for a robot is to move objects to a pallet at the end of the production line. Robots may be used to move objects into the boxes along the conveyor path.

When the dynamic market requires frequent changes of production volumes, types and methods, substantial financial outlays need to be made to reconfigure the production line. Often new machinery replaces previous machinery, which comes at a great cost. The previous machinery, however, often still is viable and usable. The previous machinery may be stored in a warehouse for future use, which is costly and the machinery typically loses value over time. Replacing machinery when reconfiguring the production line thus leads to waste of resources and time. Furthermore, such reconfiguration can lead to safety breaches, unplanned stoppages, and an unreliable production output.

There is therefore a need for improved conveyor systems for robotic production lines and for means enabling such systems.

### SUMMARY

It is an object of the present disclosure to provide means for improving conveyor systems, which alleviate at least some of the above-mentioned issues. In particular, it is an object to provide an interface providing improved flexibility and configurability in modular conveyor systems. This object is at least in part achieved by an interface adapted to be arranged on a first conveyor system module and adapted to releasably interconnect with a corresponding interface on a second conveyor system module. The interface comprises first electric connection means configured to supply power between the first and the second conveyor system modules, second electric connection means configured to transmit control signals between the first and the second conveyor system modules, magnetic attachment means configured to magnetically attach the first conveyor system module to the second conveyor system module, and mechanical alignment means configured to align the interface of the first conveyor system module with the corresponding interface of the second conveyor system module.

The interface provides flexibility to a modular conveyor system. The respective interfaces in such system can e.g. be arranged on respective bases of each module such that the modules can be moved around on e.g. a production floor and be reconfigured into various production line layouts. The interface may provide power supply and signal exchange, including safety control signals.

Such modular conveyor system may comprise any number of modules. The modules can be repositioned and reconfigured to fulfill different requirements in a production line, such as packaging or re-packing operations. The modules are designed to be connected together in order to form small to large production lines. Furthermore, a robot arm of a robot module can be equipped with different heads comprising miscellaneous tools varying in functionality and purpose. A plurality of conveyor modules may be interconnected and be arranged to reach a required layout of an overall conveyor path. The modular conveyer system thus provides a flexible and cost-efficient system, which can be adapted to a variety of products, packs, cartons, trays etc. scalable according to production capacity needs

The magnetic attachment means securely attach two interfaces, and correspondingly two modules, to each other. Such secure attachment is highly desirable when power (such as mains electricity) is supplied through the interface.

The first and the second electric connection means provide power supply and signal exchange, including safety control signals.

The mechanical alignment means facilitate a secure connection of interfaces, which is also an important safety aspect.

The magnetic attachment means, the first and the second electric connection means, and the mechanical alignment means thus enable interconnected modules to establish a functioning safety system. The modules may be freely repositioned, i.e., connected in different ways, without the need of recertification of any safety regulation. This is in contrast to typical conveyor systems that need to reevaluate safety of joint-machinery every time anything is changed

According to some aspects, the first electric connection means and the second electric connection means are grouped together in a connector. In that case, the connector is arranged on a resilient member. The resilient member allows some misalignment between two interconnected interfaces, which facilitates interconnecting two modules. For example, if one module on a floor is rotated slightly, such as less than 3 degrees, along a vertical axis from the floor relative to an intended straight orientation for interconnection, that module may still be pushed towards another module and be interconnected. In that case, the resilient member will compensate for the misalignment.

According to some aspects, the magnetic attachment means comprise an electromagnet and/or a ferromagnetic member adapted to attach to an electromagnet of the corresponding interface. This provides a strong mechanical attachment. Such magnetic attachment means may e.g. provide a holding force over 900 N.

According to some aspects, the interface further comprises radio frequency interrogation means provided with a radio frequency tag and/or a radio frequency tag reader. The radio frequency interrogation means enable one module to detect other modules in a robust way. For example, the modules can be configured to only activate the interfaces if the radio frequency interrogation means of the two interfaces successfully interconnects. Here, a successful interconnection can mean that a tag reader successfully reads a tag. To activate the interfaces can mean to allow electric power transmission between interfaces.

According to some aspects, the magnetic attachment means and the radio frequency interrogation means are grouped together in a housing. This provides a small footprint.

According to some aspects, the mechanical alignment means comprise one of a first rim and a first rim receiving arrangement configured to receive the first rim, wherein the first rim or first rim receiving arrangement is arranged on a first surface and arranged extending away from the first surface, and wherein the first electric connection means, the second electric connection means, and the magnetic attachment means are arranged on the first surface. A first pair comprising the first rim and the first rim receiving enclosure provides a simple yet effective way to align the interface of a first conveyor system module with a corresponding interface of a second conveyor system module.

According to some aspects, the first rim or the first rim receiving arrangement is arranged at least partly surrounding the first electric connection means, the second electric connection means, and the magnetic attachment means. This way, all three of said connection/attachment means may be properly aligned when interconnecting the interface of a first conveyor system module with a corresponding interface of a second conveyor system module. The first rim or a first rim receiving arrangement also physically protects all three of said connection/attachment means.

According to some aspects, the mechanical alignment means comprise one of a second rim and a second rim receiving arrangement configured to receive the second rim, wherein the second rim or second rim receiving arrangement is arranged on the first surface and arranged extending away from the first surface, and wherein the second rim or second rim receiving arrangement is arranged at least partly surrounding the first electric connection means and the second electric connection means. A second pair comprising the second rim and the second rim receiving arrangement provides a simple yet effective way to align the interface of a first conveyor system module with a corresponding interface of a second conveyor system module. With the second pair, the first electric connection means and the second electric connection means may be properly aligned when interconnecting the interface of a first conveyor system module with a corresponding interface of a second conveyor system module. The second pair further physically protects the first and second electric connection means.

According to some aspects, the first rim or first rim receiving arrangement extends further from the first surface than the second rim or second rim receiving arrangement arranged on the same interface. This improves the mechanical alignment between two interconnected interfaces and facilitates the interconnection of the two interfaces. As the two interfaces are approaching each other during interconnection, the first pair will connect and align before the second pair connects and aligns. This provides a finer alignment for the second pair, which at least partly surrounds the first electric connection means and the second electric connection means, which in turn are more likely to require a more precise alignment compared to the attachment means.

According to some aspects, the mechanical alignment means comprise one of a first protrusion and a first guiding space, wherein the first guiding space and the first protrusion have at least partly complementary shapes, where the first guiding space is arranged to receive the first protrusion when the first conveyor system module is interconnected with the second conveyor system module. In that case, the first protrusion may extend further from the first surface than the first rim or first rim receiving arrangement. This improves the mechanical alignment between two interconnected interfaces and facilitates the interconnection of the two interfaces. As the two interfaces are approaching each other during interconnection, the first protrusion will interact and align with the first guiding space before the first pair connects and aligns. This way, the mechanical alignment of the two interfaces about to interconnect is done in steps. Here, each step can align the two interfaces to larger and larger degrees, i.e., finer and finer.

According to some aspects, the mechanical alignment means comprise one of a second protrusion and a second guiding space, wherein the second guiding space and the second protrusion have at least partly complementary shapes, where the second guiding space is arranged to receive the second protrusion as the first conveyor system module is interconnected with the second conveyor system module, wherein the second guiding space is arranged on the first protrusion. This improves the mechanical alignment between two interconnected interfaces and facilitates the interconnection of the two interfaces. As the two interfaces are approaching each other during interconnection, the first protrusion will first interact and align with the first guiding space. As the two interfaces are approaching each other, the second guiding space arranged on the first protrusion will eventually interact and align with the second protrusion. This way, the mechanical alignment of the two interfaces about to interconnect is done in steps. Here, each step can align the two interfaces to larger and larger degrees.

According to some aspects, the wherein the mechanical alignment means comprise one of a third protrusion and a third guiding space, wherein the third guiding space and the third protrusion have at least partly complementary shapes, where the third guiding space is arranged to receive the third protrusion when the first conveyor system module is interconnected with the second conveyor system module, wherein the third guiding space or the third protrusion is arranged on the second rim or second rim receiving arrangement. This improves the mechanical alignment between two interconnected interfaces and facilitates the interconnection of the two interfaces. In particular, such arrangement facilitates interconnection of the first electric connection means and the second electric connection means of the two interfaces.

According to some aspects, the first protrusion, second protrusion, third protrusion, first guiding space, second guiding space and/or third guiding space is at least partly tapered. This way, the mechanical alignment means may be self-aligning.

There is also disclosed herein a conveyor module for a modular conveyor system. The conveyor module comprises a conveyor configured to convey objects, and at least one interface according to the discussions above.

There is also disclosed herein a robot module for a modular conveyor system. The robot module comprises a robot arm provided with a head configured to interact with objects, and at least one interface according to the discussions above.

There is also disclosed herein a power module for a modular conveyor system. The power module comprises a power inlet and one or more power outlets, the power module being configured to supply power to other modules in the modular conveyor system, the power module further comprising at least one interface according to the discussions above.

Further features of, and advantages with, the present disclosure will become apparent when studying the following description.

### BRIEF DESCRIPTION OF THE DRAWINGS

With reference to the appended drawings, below follows a more detailed description of embodiments of the present disclosure cited as examples. In the drawings:

FIG. 1A FIG. 1B FIGS. 1A and 1B show modular conveyor systems;

FIG. 2A FIG. 2B FIGS. 2A and 2B show different views of a conveyor module;

FIG. 3A FIG. 3B FIGS. 3A and 3B show different views of a robot module;

FIG. 4A FIG. 4B FIGS. 4A and 4B show different views of a power module; and

FIG. 5A FIG. 5B FIGS. 5A and 5B show respective interfaces.

### DETAILED DESCRIPTION

The present disclosure will now be described more fully hereinafter with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

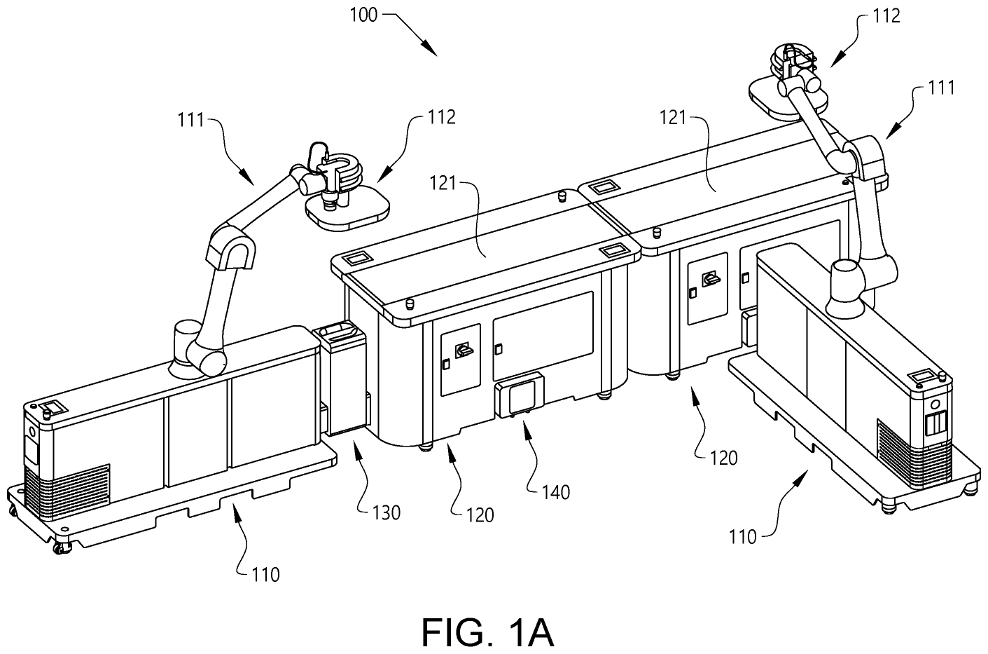

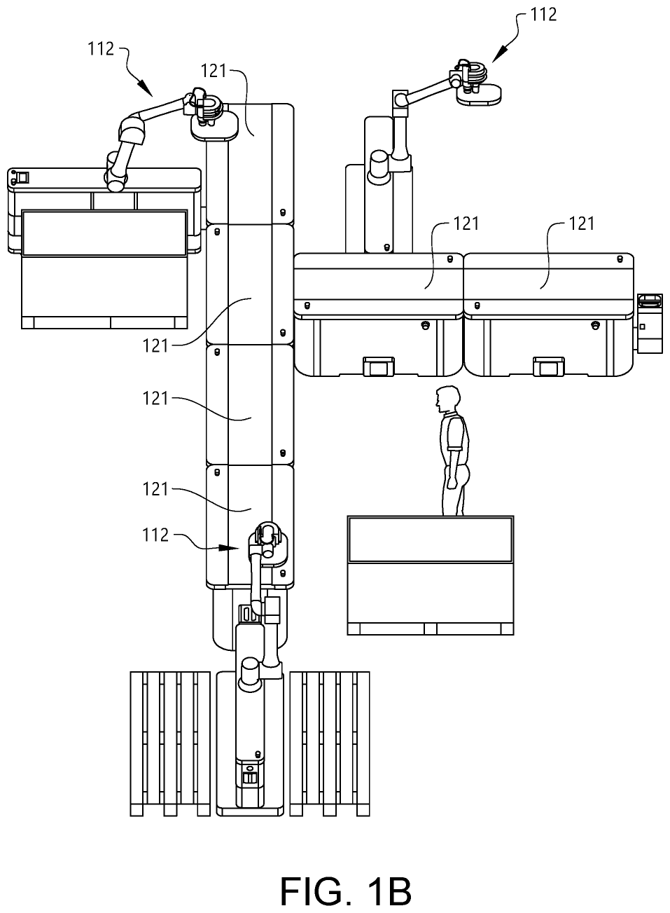

As mentioned, there is a need for improved conveyor systems for robotic production lines. The present disclosure therefore presents a modular conveyor system 100 comprising a plurality of conveyor system modules 110, 120, 130. Respective example modular conveyor systems 100 are shown in FIGS. 1A and 1B. The plurality of modules are at least a conveyor module 120, a robot module 110, and a power module 130. The conveyor module 120 is provided with a conveyor 121 configured to convey objects, such as a package or box. The robot module 110 comprises a robot arm 111 provided with a head 112 configured to interact with objects at least on the conveyor 121. The power module 130 is provided with a power inlet and one or more power outlets, where the power module is configured to supply power to the conveyor module 120 and the robot module 110.

The modular conveyor system may comprise any number of these modules. Typically, however, only a single power module is needed for one interconnected system. A plurality of systems may be operated in parallel, where each system comprises respective plurality of interconnected modules with respective power modules.

The modules can be repositioned and reconfigured to fulfill different requirements in a production line. The modules are designed to be connected together in order to form small to large production lines. Furthermore, the robot arm can be equipped with different heads comprising miscellaneous tools varying in functionality and purpose. A plurality of conveyor modules may be interconnected and be arranged to reach a required layout of an overall conveyor path.

The modules are preferably connected to each other in a so-called click and play fashion, meaning that each module may connect with the next one in a simple manner, where power is supplied via the connection interface. Therefore, each module 110, 120, 130 comprises an interface 140 adapted to releasably interconnect with a corresponding interface on another module. These interfaces provide flexibility of the modular conveyor system 100. The respective interfaces may e.g. be arranged on respective bases of each module such that the modules can be moved around on a production floor and be reconfigured into various production line layouts. The interface may provide power supply and signal exchange, including safety control signals.

In particular, the interface 140 comprises an electric connection arrangement 510 configured to electrically connect two interconnected modules 110, 120, 130 and attachment means configured to releasably attach two interconnected modules 110, 120, 130. The two interconnected modules may be any two of the conveyor module 120, the robot module 110, and the power module 130. The two interconnected modules may also be two different modules of the same type. The attachment means may e.g. comprise a snap fit connection. Alternatively, or in combination of, the attachment means may comprise magnetic attachment means. Furthermore, the interface 140 may further comprise mechanical alignment means configured to align respective interfaces of two interconnected modules 110, 120, 130.

The electric connection arrangement 510 may comprise first electric connection means 511 configured to supply power between two interconnected modules 110, 120, 130, and second electric connection means 512 configured to transmit control signals between two interconnected modules. The interface and corresponding attachment/connection means are discussed in more detail later in this document.

Preferably, the conveyor module 120, robot module 110, and/or power module 130 comprises at least two interfaces 140 each. In particular, the conveyor module 120 preferably comprises four interfaces 140 facing different directions. This way, one or more robot modules may be interconnected with a conveyor module in different orientations.

In the example of FIG. 1A, the modular conveyor system 100 comprises a first and a second conveyor module that are interconnected to form an overall conveyor path in a line, which is adapted to transport objects from one end to the other. A power module 130 is interconnected with the first conveyor module, which is the leftmost conveyor module in the figure, at a narrow side of the first conveyor module. A first robot module 110 is interconnected with the power module, and a second robot module 110 is interconnected with the second conveyor module at a broad side of the second conveyor module.

In FIG. 1A, the power module is provided with a power inlet, which is configured to connect to mains electricity. The power module is configured to supply power to the other modules. In this example, the power module comprises two interfaces with respective first electric connection means, which constitute respective power outlets. The power module supplies power to the first robot module and to the first conveyor module directly via the two interfaces. The power module supplies power to the second conveyor module via the first conveyor module. The power module further supplies power to the second robot module via the first and the second conveyor modules.

Furthermore, in FIG. 1A, the robot arm of the first robot module is adapted to interact with objects on the first conveyor module and the robot arm of the second robot module is adapted to interact with objects on the second conveyor module. For example, the first robot module may be arranged to move objects from a packaging station to the conveyor and the second robot module may be arranged to move objects from the conveyor to another packaging station.

In the example of FIG. 1B, the modular conveyor system 100 comprises four conveyor modules that are interconnected to from a first conveyor path in a first line. The system further comprises two conveyor modules that are interconnected to a second conveyor path in a second line. The second line is perpendicular to the first line and the second conveyor path is arranged in connection to the first conveyor path. A first robot module is interconnected with a conveyor module in the first line at a narrow side of that conveyor module. Two pallets are arranged along respective broad sides of the first robot module. A second robot module is interconnected with conveyor module in the second line at a broad side of that conveyor module. A third robot module is interconnected with a conveyor module in the first line at a broad side of that conveyor module. A pallet comprising a box is arranged along a broad side of the third robot module.

Furthermore, in FIG. 1B, the robot arm of the first robot module is adapted to interact with objects on the conveyor module in the first line and objects on the adjacent pallets. The robot arm of the second robot module is adapted to interact with objects on both conveyor paths. For example, the second robot module may be arranged to move objects from the first conveyor line to the second conveyor line. The robot arm of the third robot module is adapted to interact with objects on the conveyor module in the first line and objects on the adjacent pallet with a box.

The modular conveyor system 100 in FIG. 1B also comprises a power module interconnected with a conveyor module in the second line. This power module is provided with a power inlet and is configured to supply power to the other modules.

The modular conveyor system 100 may comprise other modules than the conveyor module, the robot module, and the power module. Any such other module also comprises the interface according to the discussions herein. For example, the modular conveyor system may comprise a case-forming module configured to form cases conveyed on the conveyor 121, a case sealer module configured to seal cases conveyed on the conveyor 121, and/or a labeler module configured to label cases conveyed on the conveyor 121. The case-forming module may be configured to erect and/or fold cases from flat or knockdown blanks. The case-forming module may further be interconnectable to a conveyor module and comprise means for pushing cases onto the conveyor. Alternatively, the case-forming module may be interconnected between two conveyor modules. In that case, the case-forming module may also comprise a conveyor configured to connect the respective conveyors of the two interconnected conveyor modules. The case sealer module and the labeler module may be arranged in a similar fashion as the case-forming module.

The modular conveyor system 100 may be supported by software that handles a workflow of the modules, and optionally operation of a fleet of machinery within an enterprise. The software may provide data of production efficiency, a maintenance schedule, and line status.

The software may provide pre-designed layouts and possible configuration of how various numbers of modules can be connected, which allows rapid changes of the production line. The software may calculate positions of the robots, robot movements, conveyor movements etc. to provide a desired flow on the production line. The software may further provide step-by-step instructions of how to configure and interconnect modules for a selected layout. The flow of objects on the production line and functionality of the modules may be reprogrammed to ensure adaptability to different needs.

Furthermore, the modular conveyor system 100 may be connected to a main control device configured to control and monitor the modular conveyor system. Such main control device for conveying systems is known in general and will not be discussed further herein.

At least one module 110, 120, 130 may comprise stop means configured to, upon activation, stop an operation of each module by transmitting a control signal between interconnected modules via respective interfaces 140. The stop means may e.g. comprises a stop button 210, 310 configured to stop the operation upon activation, i.e., when pressed.

The interconnected modules may thus establish a functioning safety system. In the disclosed modular conveyor system 100, the modules may be freely repositioned, i.e., connected in different ways, without the need of recertification of any safety regulation. This is in contrast to typical conveyor systems that need to reevaluate safety of joint-machinery every time anything is changed.

The stop means may alternatively, or in combination of, comprise a contact sensor configured to stop the operation upon detecting contact with an object and/or person. Such sensor may e.g. be arranged around the head of the robot arm. Furthermore, the stop means may alternatively, or in combination of, comprise a light sensor configured to stop the operation upon detection of an object and/or person.

Each module 110, 120, 130 may comprises a reset switch configured to, upon activation, reset an operation of each module by transmitting a control signal between interconnected modules via respective interfaces. In that case, all but one reset switches of interconnected modules 110, 120, 130 are disabled. Reset an operation of a module may mean to reset that module into a predetermined start condition. For example, the robot arm of a robot module may have a predetermined start orientation that the robot arm is reset into upon activation of the reset switch. Similarly, a conveyor module comprising a conveyor belt may have a predetermined start position of the belt. This configuration of the reset switches provides safety to the modular conveyor system since there is only one reset access, which reduces the risk of accidental resets of the system.

The control signals from the stop means, the control signals from the reset switch, and other safety signals may be controlled via programmable logic device (PLD). Each module may comprise a respective PLD that stops operation of the corresponding module upon detection of any of the mentioned signals, which may be sent from e.g. another module, or from the stop means or the reset switch. This can help providing safety guarantees, which enables the possibility of collaborative work with people in a production line comprising the modular conveyor system.

Below follows a more detailed description of the conveyor module, the robot module, the power module, and the interface.

### Conveyor Module

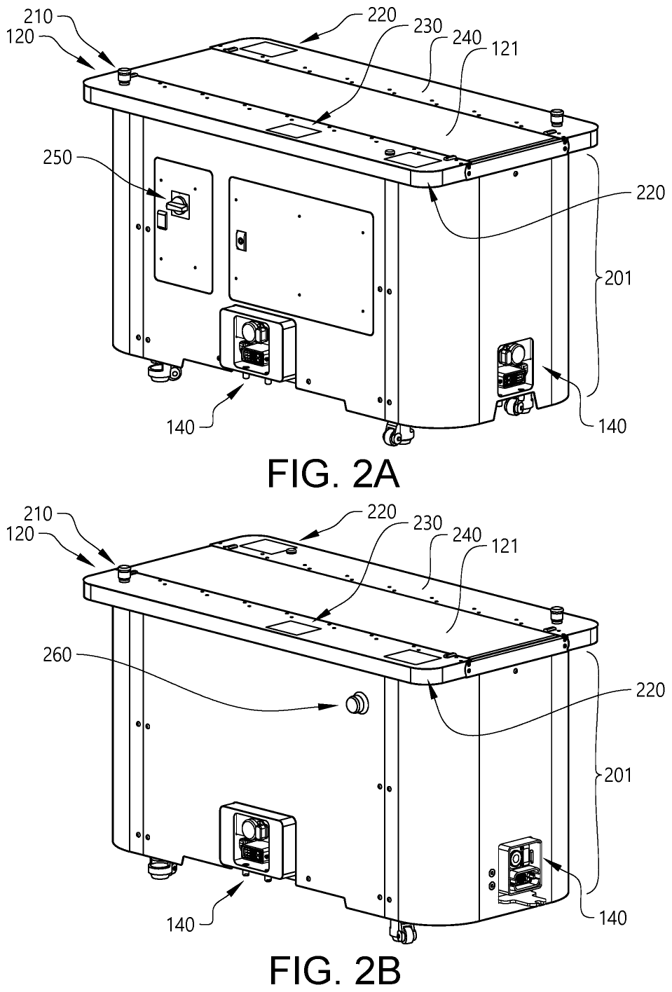

FIGS. 2A and 2B show different views of an example conveyor module 120.

The conveyor 121 may be a belt conveyor, as is shown in the example of FIGS. 2A and 2B. Alternatively, the conveyor may be a chain conveyor. Furthermore, the conveyor module 120 may comprise a base 201 and a top portion 240 arranged on to that base, as is also shown in FIGS. 2A and 2B. In that case, the conveyor may be arranged on that top portion. The top portion may comprise one or more foldable portions along one or both sides along the conveyor. Such foldable portions may be arrangeable in first position to form a planar surface and be arrangeable in a second, folded down, position to form a relatively smaller cross section of the conveyor module. In the example of FIGS. 2A and 2B, the top portion comprises two foldable portions along respective sides of the conveyor. The conveyor module may also comprise wheels arranged on the base, as is also shown in the figures.

The conveyor module 120 may e.g. have a height from 80 to 100 cm from the floor. Seen from above (relative to the floor), the footprint of the conveyor module may e.g. be 150 cm by 80 cm. If the conveyor module comprises a top portion 240 with foldable portions, such footprint may be measured when the foldable portions are in the second, folded down, position. The cross section of the top may be 150 cm by 120 cm when the foldable portions are in the first position.

The conveyor module 120 may have a capacity to carry up 50 kg on the conveyor, although larger weights are also possible. A typical conveyor speed can be 0.5 to 3 m/s.

A belt conveyor may be designed to allow a gap of maximum 25 mm between interconnected conveyor modules 120. Furthermore, the conveyor 121 should preferably be designed to be able to run backward and forward. It should further be able to do so without losing its centering position. For example, it the conveyer is a belt conveyor, the belt should not lose its centering position on its track. The belt material should preferably be able to sustain nonabrasive product, and most used cleaning products. The belt conveyor may be 150 cm long and 40 cm wide. The conveyor may be motorized by a 24 VDC drive or 220/110 VAC inverter.

The conveyor module 120 may comprise a contactless power supply 230 for suppling power to auxiliary equipment. The contactless power supply supplies electrical energy without wires as a physical link. The contactless power supply preferably uses near field energy transfer, where power is transferred by magnetic fields using inductive coupling. In the example of FIGS. 2A and 2B, a contactless power supply 230 is arranged on the top portion 240. The contactless power supply may be arranged to transfer up 10 A. The voltage may e.g. be 24 VDC. The auxiliary equipment may e.g. be a printer or a camera.

The conveyor module 120 may comprise an electronic display 220 configured to display calibration imagery, and wherein the robot arm 111 comprises a visual sensor configured to sense the calibration imagery. This way, the robot arm may be calibrated automatically in relation to the position of the conveyor module to which it is connected. In the example of FIGS. 2A and 2B, two electronic displays arranged on respective corners of the top portion 240. The electronic display may be a touch screen. In that case, an operator may provide commands such as start and stop of the conveyor. The electronic display may be a 5 cm by 11 cm display. In addition to displaying calibration imagery, the electronic display may display information about the conveyor module, such as on/off status.

The conveyor module 120 may comprise illumination means configured e.g. to show a status of the module, such as on, off, operating the conveyor etc. The illumination may comprise LED strips. Such strips may be arranged on a side of the top portion.

The conveyor module 120 may comprise one or more object sensors configured to sense objects on the conveyor. Preferably, the conveyor module comprises an infeed sensor arranged to detect objects entering the conveyor and an outfeed sensor arranged to detect objects exiting the conveyor. Such sensors may e.g. comprise a camera, a laser detector, an infrared sensor.

The conveyor module 120 may comprise a control unit. The control unit may e.g. be arranged to control the conveyor module, such as controlling the belt of the belt conveyor and/or the mentioned object sensors. The control unit may have a connection for communication via a machine-to-machine network protocol, such as MQ Telemetry Transport (MQTT), to the main control device mentioned above. The connection for communication may be via an Ethernet connector and/or a WiFi device. An example WiFi antenna 260 is shown in FIG. 2B. The control unit of the conveyor module may communicate its activity, such as an amount of objects that has been conveyed, to the main control device.

The conveyor module 120 may further comprise a DC power supply for suppling power to e.g. the contactless power supply and the control unit of the conveyor module. The DC power supply may be connected to an inverter arranged to invert AC mains power to DC power. The conveyor module 120 may also comprise one or more electronic fuses for mains power and/or DC power. The control unit, DC power supply, inverter, and/or electronic fuses may be arranged in an enclosed cabinet arranged on the base of the conveyor module.

The conveyor module 120 may also comprise a service switch 250, as is shown in the example of FIGS. 2A and 2B, configured to disconnect electrical power. In other words, any component consuming power on the module is disconnected. This way, service can be performed on the module in a safe way.

The conveyor module 120 may comprise one or more guide rails for mounting of auxiliary equipment. Such guide rails may be arranged on the top portion 240. The guide rails are preferably arranged in connection to the contactless power supply 230.

As mentioned, each module 110, 120, 130 may comprise stop means and/or a reset switch. In the example of FIGS. 2A and 2B, respective stop button constituting the stop means are arranged on opposite corners on the top portion. The conveyor module may also be equipped an Ethernet safe module arranged to transmit and receive safety control signals (such as reset signals and/or stop signals) via a local area network.

The example conveyor module 120 in FIGS. 2A and 2B comprises four interfaces 140. In particular, respective interfaces are arranged on the two broad sides of the base and respective interfaces are arranged on the two narrow sides of the base. One of the interfaces arranged on the narrow sides is a female version of the interface, as is shown in FIG. 2A. The interface arranged on the other narrow side is a male version of the interface. The two interfaces arranged on the two broad sides are also the female version. The male and female versions are discussed in more detail further below in this document.

### Robot Module

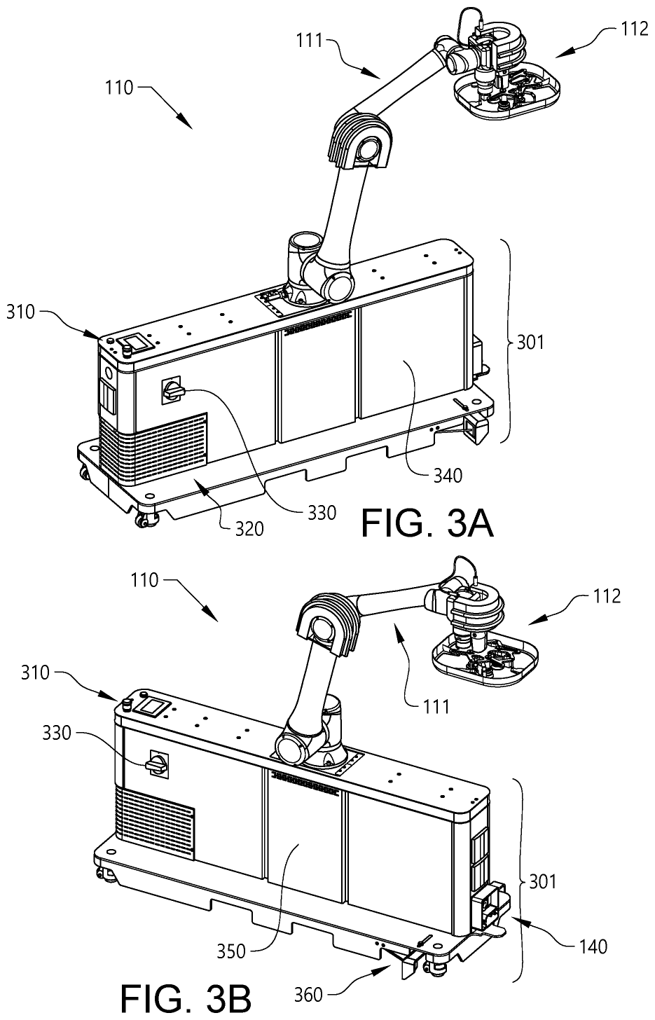

FIGS. 3A and 3B show different views of an example robot module 110.

The robot arm 111 may be arranged on a base 301, as is shown in the example of FIGS. 3A and 3B. The base of the robot module 120 may e.g. have a height from 80 to 100 cm from the floor. Seen from above, the footprint of the base may e.g. be 150 cm by 80 cm. The robot module may also comprise wheels arranged on the base, as is also shown in the figures.

The robot module 110 may further comprise means for docking one or more pallets. In the example of FIGS. 3A and 3B, a respective pallet may be docked onto the two broad sides of the base. Furthermore, the example robot module in the figures comprise respective retractable pallet locators 360 on the two broad sides. The retractable pallet locators are arranged to align respective pallets when docked onto the robot module and are retractable to reduce the footprint of the robot module when not in use. The robot module may also be equipped with sensing means configured to detect the presence of one or more pallets arranged docked to the robot module.

The robot arm 111 may be a six-axis robot arm. Furthermore, the robot arm may be arranged on a stroke pedestal 350 arranged in the base 301 of the robot module. Such stroke pedestal may have a stroke length of 50 cm. Furthermore, such stroke pedestal may be used as a seventh axis for the robot arm.

As the robot module 110 is interconnected with a conveyor module 120 or a power module 130, the robot arm is preferably calibrated automatically, regardless of the configuration. Such calibration may be via the mentioned digital display arranged on the conveyor module and the visual sensor arranged on the robot arm that configured to sense the calibration imagery. This way, the robot arm may be calibrated automatically in relation to the position of the conveyor module to which it is connected. Reconfiguration of the modular conveyor system is therefore quick and easy. The calibration is preferably automatic no matter which interface of the conveyor module the robot module is interconnected with (if the conveyor module comprises several interfaces).

The head 112 may be releasable attached to the robot arm 111. Preferably, the attachment of the head allows tool less mounting and demounting of the head to the arm. The head is preferably pick-up head arranged to grip objects on the conveyor. The robot arm may comprise means to obtain an identification of the head, such as a unique identification number or model type. For example, the robot arm may be equipped with potentiometer, such as a micro switch type. A connection between the head and the robot arm may transfer electric power and electric control signals.

The head 112 and robot arm may further comprise a vacuum conduit. Such conduit may e.g. have a diameter of 10 mm. The head may in that case be provided with vacuum suction cups arranged to attach to objects on the conveyor. The base of the robot module may in that case be provided with a vacuum pump 320 arranged to provide a vacuum to the vacuum suction cups via the vacuum conduits. The base may further be provided with a relay for turn the vacuum pump off when it is not needed.

As mentioned, each module 110, 120, 130 may comprise stop means and/or a reset switch. In the example of FIGS. 3A and 3B, a stop button constituting the stop means is arranged on a corner on the base 301 of the robot module 110. Alternatively, or in combination of, the robot module is provided with contact sensor configured to stop the operation upon detecting contact with an object and/or person. Such contact sensor may e.g. be arranged on the robot arm 111 and/or the head 111. The contact sensor may comprise a shroud arranged around the head, as is shown in the example of FIGS. 3A and 3B. The robot module is preferably also provided with one or more safety scanners, such as sensors, on the base. Such safety scanners may be configured to scan for undesired objects or persons around the robot arm and be arranged to stop operation of the robot arm upon detection of such undesired objects or persons.

The robot module may also be equipped an Ethernet safe module arranged to transmit and receive safety control signals (such as reset signals and/or stop signals) via a local area network.

The robot module 110 may comprise a control unit. The control unit may e.g. be arranged to control the robot module, such as controlling the robot arm and/or head. The control unit may have a connection for communication via a machine-to-machine network protocol, such as MQTT, to the main control device mentioned above. The connection for communication may be via an Ethernet connector and/or a WiFi device. The control unit of the robot module may communicate its activity, such as an amount of objects that has been manipulated by the robot arm, to the main control device.

Two robot arms 111 of respective robot modules 110 operate in overlapping or adjacent areas. For example, when two robot modules are interconnected with the same conveyor module, both robot arms may interact with objects on the conveyor of that conveyor module. The control units of the two robot modules may synchronize the movement of the robot arms to avert any collisions for example. Signals may in that case be transmitted between the two control units via the interfaces of the two robot modules and via the interconnected interfaces on the conveyor module.

The robot arm may have a capability of learning motion thru a human-machine-interface (HMI) via a free drive mode, i.e., direct control of the arm by a human. The HMI may e.g. be provided on a touch screen arranged on the base of the robot module. It may also be provided via a remote computing unit in communication with the control unit of the robot module. Preferably, a standard function for pick and place is integrated in the HMI, allowing a creation of any pick-up points and/or place points with e.g. 5 points in a suggested trajectory of the robot arm and head. Such points may be entered manually as coordinates and/or by moving the robot with the free drive mode.

The robot module 110 may further comprise a DC power supply for suppling power to e.g. the control unit of the robot module. The DC power supply may be connected to an inverter arranged to invert AC mains power to DC power. The robot module 110 may also comprise one or more electronic fuses for mains power and/or DC power. The control unit, DC power supply, inverter, and/or electronic fuses may be arranged in an enclosed cabinet 340 arranged on the base of the robot module.

The robot module 110 may also comprise a service switch 310, as is shown in the example of FIGS. 3A and 3B, configured to disconnect electrical power. In other words, any component consuming power on the module is disconnected. This way, service can be performed on the module in a safe way.

The robot module 110 may comprise illumination means configured e.g. to show a status of the module, such as on, off, presence of a pallet etc.

The example robot module 120 in FIGS. 3A and 3B comprises a single interface 140. In particular, that interfaces is arranged at narrow side of the base of the robot module. This interface is a male version of the interface arranged to interconnect with a female version of the interface on e.g. a conveyor module. The male and female versions are discussed in more detail further below in this document.

### Power Module

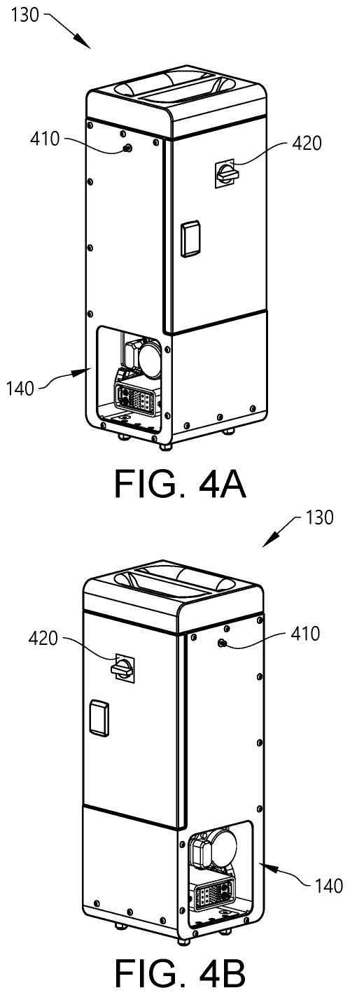

FIG. 4A and B show different views of an example power module 130.

The power module 130 may e.g. have a height from 60 to 100 cm from the floor. Seen from above, the footprint of the power module may e.g. be 30 cm by 30 cm. The power module may also comprise wheels arranged on a bottom of the module.

The power module 130 may comprise a control unit. The control unit may e.g. be arranged to control the power module, such as controlling the mains switch 420, which is shown in the example of FIGS. 4A and 4B. The control unit may have a connection for communication via a machine-to-machine network protocol, such as MQ Telemetry Transport (MQTT), to the main control device mentioned above. The connection for communication may be via an Ethernet connector and/or a WiFi device. The control unit of the power module may communicate its activity, such as whether a connection to mains electricity is live, to the main control device.

The power module 130 may further comprise a DC power supply for suppling power to the control unit of the power module. The DC power supply may be connected to an inverter arranged to invert AC mains power to DC power. The power module 130 may also comprise one or more electronic fuses for mains power and/or DC power. The control unit, DC power supply, inverter, and/or electronic fuses may be arranged in an enclosed cabinet arranged on power module.

As mentioned, the mains switch 420 is configured to close and break a connection between the power inlet and the one or more power outlets. The example power module in FIGS. 4A and 4B comprises two interfaces with respective first electric connection means 511, which constitute respective power outlets. In FIG. 4A, one of the interfaces is shown. The other interface is shown in FIG. 4B and is arranged on an opposite side of the module relative to the interface in FIG. 4A. The inlet (not shown in FIGS. 4A and 4B) may comprise a connector for receiving three-phase power from mains electricity.

The power module may comprise a securing magnet 410, as is shown in the example of FIGS. 4A and 4B. Such securing magnet is configured to further secure the power module to a conveyor module or a robot module by magnetically connect to a corresponding ferromagnetic member or corresponding securing magnet.

The interface shown in the example power module in FIGS. 4A and 4B is a female version of the interface. The interface arranged on the opposite side is a male version of the interface. The male and female versions are discussed in more detail further below in this document.

### Interface

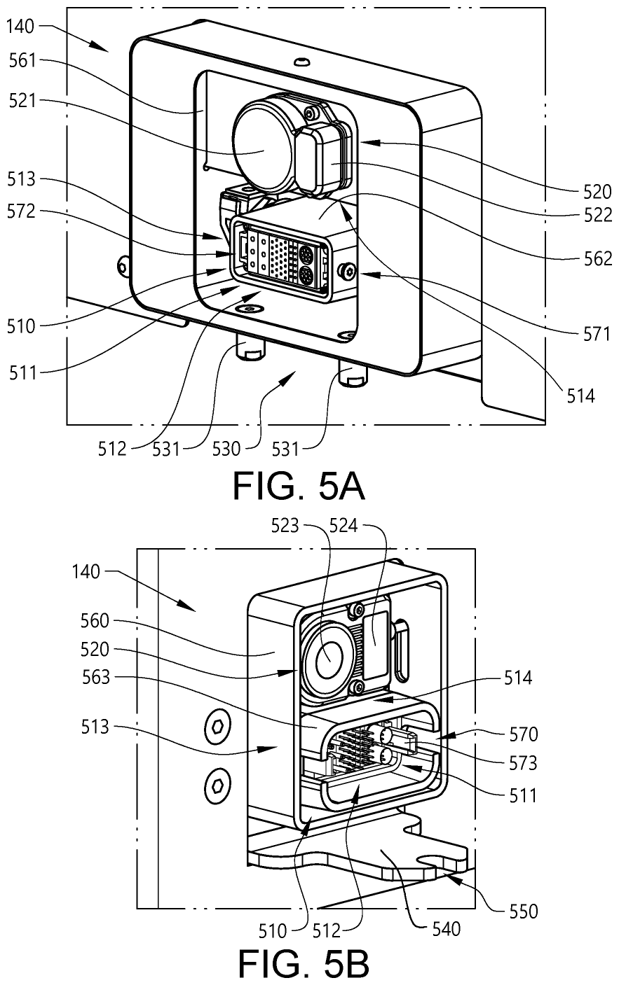

FIGS. 5A and 5B show respective example interfaces 140.

As mentioned, the conveyor module 120, the robot module 110, and the power module 130 comprise at least one interface 140 each. However, the interface is also suitable for other types of conveyor system modules. Therefore, there is also disclosed herein an interface 140 adapted to be arranged on a first conveyor system module 110, 120, 130 and adapted to releasably interconnect with a corresponding interface on a second conveyor system module.

The interface comprises, as mentioned, an electric connection arrangement 510 and attachment means. The attachment means may be magnetic attachment means. The interface may also comprise mechanical alignment means. The electric connection arrangement may comprise first electric connection means 511 and second electric connection means. The interface enables a quick and secure connection of modules. The second electric connection means may be configured to support AC power supply between the modules, such as three phase 380 VAC, 400 VAC, 440 VAC, and 480 VAC at 50 Hz or 60 Hz.

Similarly, the conveyor module, the robot module, and the power module are also suitable for other configurations than those discussed above. Therefore, there is also disclosed herein a conveyor module 120 for a modular conveyor system 100, comprising a conveyor 121 configured to convey objects, and at least one interface. There is also disclosed herein a robot module 110 for a modular conveyor system 100, comprising a robot arm 111 provided with a head 112 configured to interact with objects, and at least one interface. There is also disclosed herein a power module 130 for a modular conveyor system 100, comprising a power inlet and one or more power outlets, the power module being configured to supply power to other modules in the modular conveyor system, the power module further comprising at least one interface.

FIG. 5A shows an example of a female version of the interface and FIG. 5B shows an example of a corresponding male version of the interface. In general, having two genders of a connector/interface means that there are two different types: a first and a second type. Normally, the first type can only be interconnected with the second type. Furthermore, a connector of the first type cannot normally be interconnected with another connector of the first type. Similarly, two connectors of the second type cannot normally be interconnected. Note that the disclosed interface may also be genderless or hermaphroditical.

Furthermore, respective sub components of the interface, i.e., magnetic attachment means, mechanical alignment means, and first and second electric connection means may have female and male versions. In the female version of the interface, all sub components do not necessarily have to be female versions. Similarly, not all subcomponents of the male version of the interface have to be male versions.

The first electric connection means 511 and the second electric connection means 512 may be grouped together in a connector 513. FIG. 5B shows an example male version of such connector 513 comprising a plurality of pins. FIG. 5A shows a corresponding female version of the connector 513 comprising a plurality of holes arranged to receive the plurality of pins. It can further be seen in the example, in particular in FIG. 5A, that the pins and corresponding holes may be arranged in groups. Here, different groups may be configured for different types of signals or power supplies, such as 24 VDC and three-phase 400 VAC.

The connector 513 comprising the first and second electric connection means 511, 512 may be arranged on a resilient member 514, i.e., a pliant element. The connector 513, such as pins and an adjacent surface, may comprise a relatively stiff material. The resilient member, on which the connector is arranged, is relatively flexible. The connector may be connected to internal components of the module via cabling, which is also flexible. The resilient member 514 allows some misalignment between two interconnected interfaces, which facilitates interconnecting two modules. For example, if one module on a floor is rotated slightly, such as less than 3 degrees, on a vertical axis from the floor relative to an intended straight orientation for interconnection, that module may still be pushed towards another module and be interconnected. In that case, the resilient member 514 will compensate for the misalignment. The resilient member may e.g. comprise rubber.

FIG. 5B shows an example male version of connector 513 comprising a plurality of pins. FIG. 5A shows a corresponding female version of the connector 513 comprising a plurality of corresponding holes.

The magnetic attachment means may comprise an electromagnet 523. Such electromagnet may be arranged to attach to another electromagnet on another interface or to a ferromagnetic member 521 of the other interface. In other words, the magnetic attachment means of the interface 140 is adapted to be arranged on the first conveyor system module 110, 120, 130 may comprise a ferromagnetic member 521 adapted to attach to an electromagnet 523 of the corresponding interface 140 on the second conveyor system module 110, 120, 130. An electromagnet is a magnet where the magnetic field is generated by an electric current. A ferromagnetic member is a member comprising a ferromagnetic material such as iron, steel, nickel, cobalt, etc. which is attracted to a magnet.

FIG. 5A shows an example of a ferromagnetic member 521 and FIG. 5B shows an example of an electromagnet 523.

The electromagnet and the ferromagnetic member may be seen as male and female versions, respectively, of the magnetic attachment means.

The magnetic attachment means provides a secure attachment of two modules, which is especially desired if mains electricity is transmitted through the interconnected interfaces. The magnetic attachment means may e.g. be configured to provide a holding force in the range of 600-1500 N when activated.

The interface 140 may further comprise radio frequency interrogation means provided with a radio frequency tag 522 and/or a radio frequency tag reader 524. Such interrogation means may use radio-frequency identification (RFID). The radio frequency interrogation means uses electromagnetic fields to obtain information from a tag. The radio frequency tag reader typically comprises a radio transponder, i.e., a radio receiver and transmitter. The radio frequency tag 522 typically comprises means to transmit data upon receiving an electromagnetic interrogation pulse from the radio frequency tag reader.

FIG. 5A shows an example of a radio frequency tag 522 and FIG. 5B shows an example of a radio frequency tag reader 524.

The radio frequency tag reader 524 and the radio frequency tag 522 may be seen as male and female versions, respectively, of the magnetic attachment means.

The radio frequency interrogation means enable one module to detect other modules in a robust way. For example, the modules can be configured to only activate the interfaces if the radio frequency interrogation means of the two interfaces successfully interconnects. Here, a successful interconnection can mean that a tag reader successfully reads a tag. To activate the interfaces can mean to allow electric power transmission between interfaces.

If, on the other hand, the interfaces would activate if the magnetic attachment means successfully interconnects (e.g., an electromagnet connects to a ferromagnetic member), such system could be bypassed. For example, a permanent magnet or another ferromagnetic object could trick the magnetic attachment means of an interface that it is connected to another module.

The magnetic attachment means and the radio frequency interrogation means may be grouped together in a housing 520. This provides a small footprint.

As mentioned, the mechanical alignment means of the interface is configured to align the interface of a first conveyor system module 110, 120, 130 with a corresponding interface of a second conveyor system module. The mechanical alignment means thus increases the probability that the first electric connection means 511, the second electric connection means 512, and/or the magnetic attachment means are properly interconnected with respective counterparts on another interface. As an example, a poor connection between first electric connection means of two interconnected interfaces may result in sparks between the connection means, which may be dangerous.

The mechanical alignment means may therefore comprise one of a first rim 560 and a first rim receiving enclosure 561 configured to receive the first rim. The first rim or first rim receiving arrangement is arranged on a first surface and is arranged extending away from the first surface. The first electric connection means 511, the second electric connection means 512, and the magnetic attachment means are also arranged on the first surface. A first pair comprising the first rim 560 and the first rim receiving enclosure 561 provides a simple yet effective way to align the interface of a first conveyor system module 110, 120, 130 with a corresponding interface of a second conveyor system module.

Furthermore, the first rim 560 or the first rim receiving arrangement 561 may be arranged at least partly surrounding the first electric connection means 511, the second electric connection means 512, and the magnetic attachment means. This way, all three of said connection/attachment means may be properly aligned when interconnecting the interface of a first conveyor system module 110, 120, 130 with a corresponding interface of a second conveyor system module. The first rim or the first rim receiving arrangement also physically protects all three of said connection/attachment means.

In the example interface 140 in FIG. 5B, the first rim 560 comprises a continuous protrusion surrounding the first electric connection means 511, the second electric connection means 512, and magnetic attachment means. In the example interface 140 in FIG. 5A, the first rim receiving arrangement 560 comprises a continuous enclosure surrounding the first electric connection means 511, the second electric connection means 512, and magnetic attachment means. The first rim receiving arrangement 560 of FIG. 5A is larger than the first rim 560 and is arranged to receive and partly enclose the first rim 560 of FIG. 5B when the two interfaces are interconnected.

The first rim receiving arrangement 561 may be considered a corresponding female version of the first rim 560, where the first rim is considered a male version.

The first rim 560 and/or first rim receiving arrangement 561 may e.g. have a rectangular shape with dimensions of 10-20 cm by 10-20 cm. The first rim and/or first rim receiving arrangement may comprise a resilient material such as rubber. They may also comprise plastics and/or metal.

The mechanical alignment means may further comprise one of a second rim 562 and a second rim receiving arrangement 563 configured to receive the second rim, wherein the second rim or second rim receiving arrangement is arranged on the first surface and arranged extending away from the first surface, and wherein the second rim 562 or second rim receiving arrangement 563 is arranged at least partly surrounding the first electric connection means 511 and the second electric connection means 512. A second pair comprising the second rim 562 and the a second rim receiving arrangement 563 provides a simple yet effective way to align the interface of a first conveyor system module 110, 120, 130 with a corresponding interface of a second conveyor system module. With the second pair, the first electric connection means 511 and the second electric connection means 512 may be properly aligned when interconnecting the interface of a first conveyor system module 110, 120, 130 with a corresponding interface of a second conveyor system module. The second pair further physically protects the first and second electric connection means.

The first rim 560 or first rim receiving arrangement 561 may extend further from the first surface than the second rim 562 or second rim receiving arrangement 563 arranged on the same interface. This improves the mechanical alignment between two interconnected interfaces and facilitates the interconnection of the two interfaces. As the two interfaces are approaching each other during interconnection, the first pair will connect and align before the second pair connects and aligns. This enables a finer alignment for the second pair, which at least partly surrounds the first electric connection means 511 and the second electric connection means 512, which in turn are more likely to require a more precise alignment compared to the attachment means. This effect may be increased further if the fit of the second pair is snugger than the fit of the first pair. Here, the fit is a measure of how much larger a rim receiving arrangement is compared to the corresponding rim.

In the example interface 140 in FIG. 5A, the second rim 562 comprises a continuous protrusion surrounding the first electric connection means 511 and the second electric connection means 512. In the example interface 140 in FIG. 5B, the second rim receiving arrangement 563 comprises a continuous rim surrounding the first electric connection means 511 and the second electric connection means 512. The second rim receiving arrangement 563 of FIG. 5B is larger than the second rim 562 and is arranged to receive and partly enclose the second rim 562 of FIG. 5A when the two interfaces are interconnected.

The second rim receiving arrangement 563 may be considered a corresponding female version of the second rim 562, where the second rim is considered a male version.

The second rim 562 and/or second rim receiving arrangement 563 may e.g. have a rectangular shape with dimensions of 5-15 cm by 5-15 cm. The second rim and/or second rim receiving arrangement may comprise a resilient material such as rubber. They may also comprise plastics and/or metal.

The mechanical alignment means may comprise one of a first protrusion 540 and a first guiding space 530, wherein the first guiding space and the first protrusion have at least partly complementary shapes. The first guiding space is arranged to receive the first protrusion when the first conveyor system module 110, 120, 130 is interconnected with the second conveyor system module 110, 120, 130.

Complementary shapes means that the shape of the first guiding space corresponds to the shape of the first protrusion. For example, if the first protrusion is rectangular, the first receiving space has a shape to accommodate the rectangular shape.

The first protrusion 540 and/or the first guiding space 530 may be tapered or partially tapered. Furthermore, they are preferably tapered such that two interconnecting interfaces are self-aligning when they are about to be interconnected. For example, the first protrusion may have a triangular shape and the first guiding space may have a complementary triangular shape.

The first protrusion 540 may be arranged on the first surface and arranged extending from the first surface, where the first protrusion extends further from the first surface than the first rim 560 or first rim receiving arrangement 561. This improves the mechanical alignment between two interconnected interfaces and facilitates the interconnection of the two interfaces. As the two interfaces are approaching each other during interconnection, the first protrusion 540 will interact and align with the first guiding space 530 before the first pair connects and aligns. This way, the mechanical alignment of the two interfaces about to interconnect is done in steps. Here, each step can align the two interfaces to larger and larger degrees, i.e., a finer and finer alignment.

The first protrusion may be planar. In that case, the first protrusion may comprise two opposing faces and have a thickness between the two opposing faces, where the thickness is significantly smaller than a length of one face along the face. Significantly smaller may mean that the thickness is smaller than a tenth of said length.

In the example interface 140 in FIG. 5B, the first protrusion 540 comprises a planar protrusion arranged below the first rim 560, i.e., closer to the floor compared to the first rim. In the example interface 140 in FIG. 5A, the first guiding space 530 is formed between two rods 531. The rods are arranged on and protruding from the first rim receiving arrangement 561. The first rim receiving arrangement 561 is arranged extending from a first surface. The two rods are arranged extending in a perpendicular direction compared to the first rim receiving arrangement.

The first guiding space 530 may be considered a corresponding female version of the first protrusion 540, where the first protrusion is considered a male version.

The first protrusion 540 may e.g. have a rectangular shape with dimensions of 10-20 cm by 10-20 cm. The first protrusion 540 may comprise a resilient material such as rubber. It may also, or alternatively, comprise plastics and/or metal.

The mechanical alignment means may comprise one of a second guiding space 550 (shown in the example of FIG. 5B) and second protrusion (not shown). The second guiding space and the second protrusion have at least partly complementary shapes. The second guiding space is arranged to receive the second protrusion when the first conveyor system module 110, 120, 130 is interconnected with the second conveyor system module 110, 120, 130. Furthermore, the second guiding space 550 is arranged on the first protrusion 540. This improves the mechanical alignment between two interconnected interfaces and facilitates the interconnection of the two interfaces. As the two interfaces are approaching each other during interconnection, the first protrusion 540 will first interact and align with the first guiding space 530. As the two interfaces are approaching each other, the second guiding space arranged on the first protrusion will eventually interact and align with the second protrusion. This way, the mechanical alignment of the two interfaces about to interconnect is done in steps. Here, each step can align the two interfaces to larger and larger degrees.

The second protrusion and/or the second guiding space 550 may be tapered or partially tapered. Furthermore, they are preferably tapered such that two interconnecting interfaces are self-aligning when they about to be interconnected. For example, the second protrusion may have a triangular shape and the second guiding space may have a complementary triangular shape.

The second protrusion may be a rod similar to the rods 531. In that case, in the example of FIG. 5A, the second protrusion may be arranged below the first rim receiving arrangement 561, i.e., closer to the floor compared to the first rim receiving arrangement. Furthermore, the second protrusion may be arranged on and protruding from the first rim receiving arrangement 561, where the first rim receiving arrangement 561 is arranged extending from a first surface, and where the second protrusion is arranged extending in a perpendicular direction compared to the first rim receiving arrangement. A shape of the second guiding space 550 that is complementary to such second protrusion is shown in the example interface 140 in FIG. 5B, where the second guiding space is arranged on an outer portion of the first protrusion 540.

The second guiding space 550 may be considered a corresponding female version of the second protrusion, where the second protrusion is considered a male version.

The mechanical alignment means may further comprise one of a third protrusion 571 and a third guiding space 570, where the third guiding space and the third protrusion have at least partly complementary shapes. The third guiding space is arranged to receive the third protrusion when the first conveyor system module 110, 120, 130 is interconnected with the second conveyor system module 110, 120, 130. In addition, the third guiding space 570 or the third protrusion 571 is arranged on the second rim 562 or second rim receiving arrangement 563. This improves the mechanical alignment between two interconnected interfaces and facilitates the interconnection of the two interfaces. In particular, such arrangement facilitates interconnection of the first electric connection means 511 and the second electric connection means 512 of the two interfaces.

The third protrusion 571 and/or the third guiding space 570 may be tapered or partially tapered. Furthermore, they are preferably tapered such that two interconnecting interfaces are self-aligning when they about to be interconnected. For example, the third protrusion may have a triangular shape and the third guiding space may have a complementary triangular shape.

The third protrusion 571 may be a rod similar to the rods 531.

The example interface 140 in FIG. 5A comprises two third protrusions 571 in the form of respective screws arranged on the second rim 562. In FIG. 5A, one of the two screws is shown. The example interface 140 in FIG. 5B comprises two third guiding spaces 570 arranged on the second rim receiving arrangement 563. The third protrusions 571 are arranged on and protruding from the second rim 562. The second rim 562 is arranged extending from a first surface. The third protrusions 571 are arranged extending in respective directions, which are perpendicular to the extension direction of the second rim receiving arrangement.

The third guiding space 570 may be considered a corresponding female version of the third protrusion 571, where the third protrusion is considered a male version.

The mechanical alignment means may further comprise one of a fourth protrusion 573 and a fourth guiding space 572, where the fourth guiding space and the fourth protrusion have at least partly complementary shapes. The fourth guiding space is arranged to receive the fourth protrusion when the first conveyor system module 110, 120, 130 is interconnected with the second conveyor system module 110, 120, 130. In addition, the fourth guiding space 570 or the third protrusion 571 is arranged surrounded by the second rim 562 or second rim receiving arrangement 563. The example interface 140 in FIG. 5A comprises two fourth protrusions 573. The example interface 140 in FIG. 5B comprises two fourth guiding spaces 572. The fourth guiding space 572 may be considered a corresponding female version of the fourth protrusion 573, where the fourth protrusion is considered a male version.

Among all female and male versions of the various components of the mechanical alignment means, each interface preferably comprises a mix of female components and male components. Here, the components are the first, second, third, and fourth protrusions, and first, second, third, and fourth guiding spaces, as well as the first and second rims, and the first and second rim receiving sections. This further improves mechanical stability and facilitates alignment when interconnecting two interfaces.

Any of the control units disclosed herein may comprise processing circuitry using any combination of one or more of a suitable central processing unit CPU, multiprocessor, microcontroller, digital signal processor DSP, etc., capable of executing software instructions stored in a computer program product, e.g. in the form of a storage medium. The processing circuitry may further be provided as at least one application specific integrated circuit ASIC, or field programmable gate array FPGA.

Particularly, the processing circuitry is configured to cause the control unit to perform a set of operations, or steps, as discussed above. For example, the storage medium may store the set of operations, and the processing circuitry may be configured to retrieve the set of operations from the storage medium to cause the control unit to perform the set of operations. The set of operations may be provided as a set of executable instructions.

The storage medium may also comprise persistent storage, which, for example, can be any single one or combination of magnetic memory, optical memory, solid-state memory or even remotely mounted memory.

The control unit may further comprise an interface for communications with at least one external device. As such, the interface may comprise one or more transmitters and receivers, comprising analogue and digital components and a suitable number of ports for wireline or wireless communication.

The processing circuitry controls the general operation of the control unit, e.g., by sending data and control signals to the interface and the storage medium, by receiving data and reports from the interface, and by retrieving data and instructions from the storage medium. Other components, as well as the related functionality, of the control node are omitted in order not to obscure the concepts presented herein.

### REFERENCE SIGNS

100 modular conveyor system
120 conveyor module
121 conveyor
110 robot module
111 robot arm
112 pick-up head
130 power module
140 interface
201 base of conveyor module
210 stop button
220 electronic display
230 contactless power supply
240 top portion
250 service switch
260 antenna
301 base of robot module
310 stop button
320 vacuum pump
330 service switch
340 cabinet of the robot module
350 stroke pedestal
360 Retractable pallet locator
410 securing magnet
420 mains switch
510 electric connection arrangement
511 first electric connection means
512 second electric connection means
513 connector
514 resilient member
520 housing
521 ferromagnetic member
522 radio frequency tag
523 electromagnet
524 radio frequency tag reader
530 first guiding space
531 rod
540 first protrusion
550 second guiding space
560 first rim
561 first rim receiving arrangement
562 second rim
563 second rim receiving arrangement
570 third guiding space
571 third protrusion
572 fourth guiding space
573 fourth protrusion

1. An interface (140) adapted to be arranged on a first conveyor system module (110, 120, 130) and adapted to releasably interconnect with a corresponding interface on a second conveyor system module, the interface comprising:
first electric connection means (511) configured to supply power between the first and the second conveyor system modules (110, 120, 130),
second electric connection means (512) configured to transmit control signals between the first and the second conveyor system modules (110, 120, 130),
magnetic attachment means configured to magnetically attach the first conveyor system module (110, 120, 130) to the second conveyor system module (110, 120, 130), and
mechanical alignment means configured to align the interface of the first conveyor system module (110, 120, 130) with the corresponding interface of the second conveyor system module (110, 120, 130).

2. The interface (140) according to claim 1, wherein the first electric connection means (511) and the second electric connection means (512) are grouped together in a connector (513).

3. The interface (140) according to claim 2, wherein the connector (513) is arranged on a resilient member (514).

4. The interface (140) according to claim 1, wherein the magnetic attachment means comprise an electromagnet (523) and/or a ferromagnetic member (521) adapted to attach to an electromagnet (523) of the corresponding interface (140).

5. The interface (140) according to claim 1, further comprising radio frequency interrogation means provided with a radio frequency tag (522) and/or a radio frequency tag reader (524).

6. The interface (140) according to claim 5, wherein the magnetic attachment means and the radio frequency interrogation means are grouped together in a housing (520).

7. The interface (140) according to claim 1, wherein the mechanical alignment means comprise one of a first rim (560) and a first rim receiving arrangement (561) configured to receive the first rim, wherein the first rim or first rim receiving arrangement is arranged on a first surface and arranged extending away from the first surface, and wherein the first electric connection means (511), the second electric connection means (512), and the magnetic attachment means are arranged on the first surface.

8. The interface (140) according to claim 7, wherein the first rim (560) or the first rim receiving arrangement (561) is arranged at least partly surrounding the first electric connection means (511), the second electric connection means (512), and the magnetic attachment means.

9. The interface (140) according to claim 7, wherein the mechanical alignment means comprise one of a second rim (562) and a second rim receiving arrangement (563) configured to receive the second rim, wherein the second rim or second rim receiving arrangement is arranged on the first surface and arranged extending away from the first surface, and wherein the second rim (562) or second rim receiving arrangement (563) is arranged at least partly surrounding the first electric connection means (511) and the second electric connection means (512).

10. The interface (140) according to claim 9, wherein the first rim (560) or the first rim receiving arrangement (561) extends further from the first surface than the second rim (562) or second rim receiving arrangement (563) arranged on the same interface.

11. The interface (140) according to claim 1, wherein the mechanical alignment means comprise one of a first protrusion (540) and a first guiding space (530), wherein the first guiding space and the first protrusion have at least partly complementary shapes, where the first guiding space is arranged to receive the first protrusion when the first conveyor system module (110, 120, 130) is interconnected with the second conveyor system module (110, 120, 130).

12. The interface (140) according to claim 11, further comprising the first protrusion (540), where the first protrusion is arranged on and extending from the first surface, wherein the first protrusion extends further from the first surface than the first rim (560) or first rim receiving arrangement (561).

13. The interface (140) according to claim 11, wherein the mechanical alignment means comprise one of a second protrusion and a second guiding space (550), wherein the second guiding space and the second protrusion have at least partly complementary shapes, where the second guiding space is arranged to receive the second protrusion when the first conveyor system module (110, 120, 130) is interconnected with the second conveyor system module (110, 120, 130), wherein the second guiding space (550) is arranged on the first protrusion (540).

14. The interface (140) according to 9, wherein the wherein the mechanical alignment means comprise one of a third protrusion (571) and a third guiding space (570), wherein the third guiding space and the third protrusion have at least partly complementary shapes, where the third guiding space is arranged to receive the third protrusion when the first conveyor system module (110, 120, 130) is interconnected with the second conveyor system module (110, 120, 130), wherein the third guiding space (570) or the third protrusion (571) is arranged on the second rim (562) or second rim receiving arrangement (563).

15. The interface (140) according to claim 11, wherein the first protrusion (540), second protrusion, third protrusion (571), first guiding space (530), second guiding space (550) and/or third guiding space (570) is at least partly tapered.

16. A conveyor module (120) for a modular conveyor system (100), comprising a conveyor (121) configured to convey objects, and at least one interface according to the interface (140) of claim 1.

17. A robot module (110) for a modular conveyor system (100), comprising a robot arm (111) provided with a head (112) configured to interact with objects, and at least one interface according to the interface (140) of claim 1.

18. A power module (130) for a modular conveyor system (100), comprising a power inlet and one or more power outlets, the power module being configured to supply power to other modules in the modular conveyor system, the power module further comprising at least one interface according to the interface (140) of claim 1.
